(19) United States
(12) Patent Application Publication
(10) Pub. No.: US 2022/0386519 A1
(43) Pub. Date: Dec. 8, 2022

(54) AUTOMATED TILLAGE DISK GANG ANGLE ADJUSTMENT

(71) Applicant: AGCO Corporation, Duluth, GA (US)

(72) Inventors: Jay Anthony Leininger, Hesston, KS (US); Jared J. Koch, Hesston, KS (US)

(21) Appl. No.: 17/755,861

(22) PCT Filed: Aug. 6, 2020
(86) PCT No.: PCT/IB2020/057439

§ 371 Date: May 10, 2022

Related U.S. Application Data
(60) Provisional application No. 62/933,779, filed on Nov. 11, 2019.

(51) Int. Cl. A01B 63/00; A01B 63/111; A01B 21/08

(52) U.S. Cl. CPC A01B 63/008; A01B 63/111; A01B 21/08

(57) ABSTRACT

A tillage implement includes a frame, at least one sensor carried by the frame and configured to measure a property of soil, and at least one gang assembly carried by the frame and following the at least one sensor. Each gang assembly carries a plurality of disc blades. An adjustment mechanism is operable to change an operating parameter of the gang assembly responsive to the measured property of the soil. A method of working an agricultural field includes detecting a property of soil in the agricultural field using at least one sensor carried by a tillage implement and adjusting an operating parameter of at least one gang assembly carried by the tillage implement. The gang assembly follows the sensor as the tillage implement traverses the field. The operating parameter of the gang assembly is based at least in part on the property detected by the sensor.

### CROSS-REFERENCE TO RELATED APPLICATION

This application claims the benefit of the filing date of U.S. Provisional Patent Application 62/933,779, “Automated Tillage Disk Gang Angle Adjustment,” filed Nov. 11, 2019, the entire disclosure of which is incorporated herein by reference.

### FIELD

Embodiments of the present disclosure relate to adjusting a tillage implement. More particularly, embodiments of the present disclosure relate to apparatus and methods for measuring soil conditions and adjusting a tillage implement based at least in part on the soil conditions.

### BACKGROUND

Crop yields are affected by a variety of factors, such as seed placement, soil quality, weather, irrigation, and nutrient applications. Vegetative residue typically remains in the field after desirable portions of plants have been retrieved and processed.

In some fields and with some crops, it is beneficial to till the soil and residue before planting to enable crops roots to grow deeper and more uniformly. However, tilling deeper requires increased fuel usage and exposes more soil to moisture loss. Thus, operators balance the costs (fuel, lost moisture and nutrients) with the benefits (soil uniformity, permeability) when selecting tillage operating parameters such as gang angle and tilling depth.

### BRIEF SUMMARY

In some embodiments, a tillage implement includes a frame, at least one sensor carried by the frame and configured to measure a property of soil, and at least one gang assembly carried by the frame and following the at least one sensor. Each gang assembly carries a plurality of disc blades. An adjustment mechanism is operable to change an operating parameter of the gang assembly responsive to the measured property of the soil.

A method of working an agricultural field includes detecting a property of soil in the agricultural field using at least one sensor carried by a tillage implement and adjusting an operating parameter of at least one gang assembly carried by the tillage implement. The gang assembly follows the sensor as the tillage implement traverses the field. The operating parameter of the gang assembly is based at least in part on the property detected by the sensor.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments when read in conjunction with the accompanying drawings, in which:

FIG. 1 is a simplified perspective view of a tillage implement;

FIG. 2 is a simplified side view of a sensor and opening wheel that may be used in the tillage implement of FIG. 1;

FIG. 3 is a flow chart illustrating a method of working an agricultural field; and

FIG. 4 illustrates an example computer-readable storage medium comprising processor-executable instructions configured to embody one or more of the methods of working an agricultural field, such as the method illustrated in FIG. 3.

### DETAILED DESCRIPTION

The illustrations presented herein are not actual views of any tillage implement or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

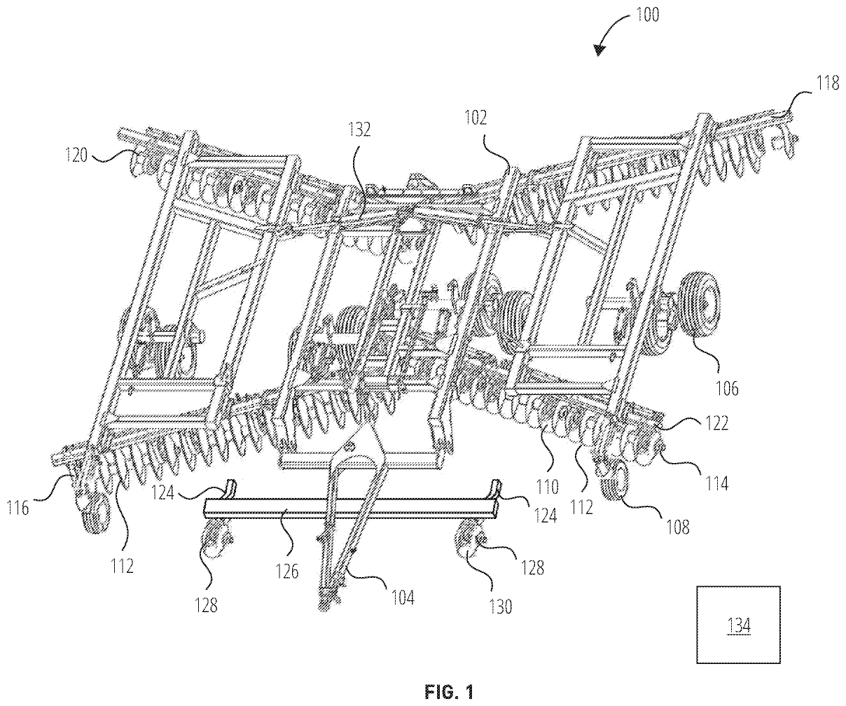

FIG. 1 illustrates a tillage implement 100 embodied as an agricultural disc harrow implement. An agricultural vehicle, such as a tractor, pulls the tillage implement 100 through an agricultural field. The tillage implement 100 includes a frame 102 having a hitch 104 on the front end that may be used to connect the tillage implement 100 to the agricultural vehicle. A set of center wheels 106 is attached across the frame 102 at positions, for example, roughly midway between the front and rear ends of the frame 102, which support the tillage implement 100 as well as providing depth adjustment, in a known manner. Additionally, a set of pivoting wheels 108 is connected to front distal ends of the frame 102 in a known manner.

The tillage implement 100 also includes a plurality of disc blades 110 mounted on one or more gang assemblies 112 attached to the frame 102. In accordance with one example configuration illustrated in FIG. 1, the gang assemblies 112 may include a front left wing 114, a front right wing 116, a rear left wing 118, and a rear right wing 120. However, one skilled in the art will understand that the gang assemblies 112 on the tillage implement 100 may be of any selected number and may be arranged in other suitable configurations. In the illustrated embodiment, the front left wing 114 and the front right wing 116 are positioned at converging angles that extend inward and rearward from outside to inside, whereas the rear left wing 118 and rear right wing 120 are positioned at converging angles that extend inward and forward from outside to inside. The front left wing 114 and the front right wing 116 are aligned with the rear left wing 118 and the rear right wing 120, respectively, such that the ground is engaged by the plurality of disc blades 110 as the tillage implement 100 is pulled by the agricultural vehicle. Each wing (114, 116, 118, 120) includes a transverse, angled support bar 122 extending substantially the length of the wing. The support bars 122 are attached to the frame 102.

The frame 102 carries at least one sensor 124, and at least one gang assembly 112 follows the at least one sensor 124. As shown in FIG. 1, the tillage implement 100 may include two sensors 124—one to lead the front left wing 114 and the rear left wing 118, and another to lead the front right wing 116 and the rear right wing 120. The sensors 124 are secured to a sensor support 126 mounted to the frame 102 or hitch 104.

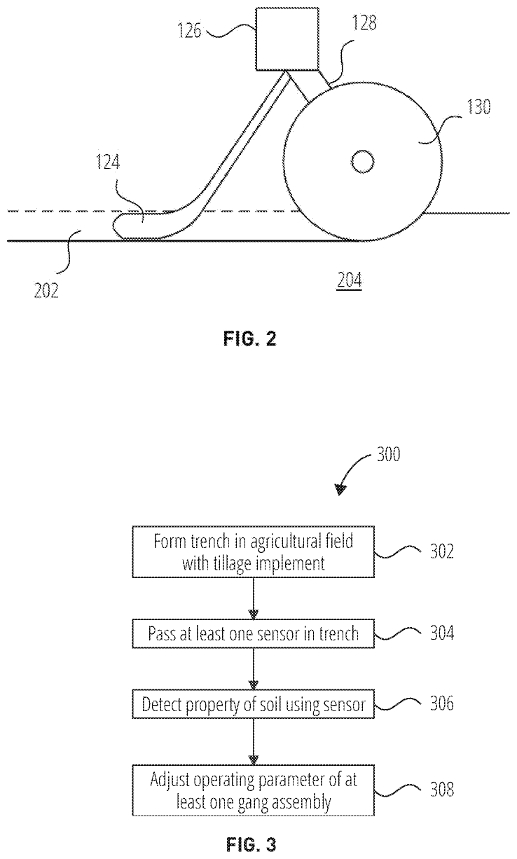

The sensor support 126 may also carry at least one trench assembly 128 leading the sensors 124. FIG. 2 shows a simplified side view of one trench assembly 128 and one sensor 124 supported by the sensor support 126. The trench assembly 128 typically includes one or more opening wheels 130 (typically two) configured to form a trench 202 in the soil 204 when the tillage implement 100 is pulled through an agricultural field. Thus, the sensors 124 can measure properties of the soil 204 at a selected depth below the surface. For example, the sensors 124 may measure the moisture content of the soil, amount of organic material, soil density, soil temperature, or any other property or combination thereof. The sensors 124 may include reflectivity sensors, electrical conductivity sensors, temperature sensors, or any other type of sensor. Soil sensors that can measure properties of soil in trenches are described in more detail in, for example, U.S. Patent Application Publication 2019/0075714 A1, “Seed Trench Closing Sensors,” published Mar. 14, 2019; and U.S. Patent Application Publication 2019/0320578 A1, “Seed Firmer and Bracket Combination,” published Oct. 24, 2019.

The tillage implement 100 may include an adjustment mechanism 132 configured to change an operating parameter of the gang assemblies 112 in response to the measured properties of the soil. For example, a high moisture and high amount of organic material may generally indicate a relatively high amount of residue. The gang assemblies 112 may be adjusted to have a higher gang angle and/or a deeper till to mix the residue into the soil. A low moisture and low amount of organic material may generally indicate a relatively low amount of residue. The gang assemblies 112 may be adjusted to have a lower gang angle and/or a shallower till to avoid nutrient loss from over-tilling. The adjustment mechanism 132 may include, for example, electrical or pneumatic actuators, levers, gears, etc. Adjustment of operating parameters is described in, for example, U.S. Pat. No. 6,612,381, “Seedbed Preparation Implement Having Rotary Disc with Adjustable Gang Angle,” issued Sep. 2, 2003; U.S. Pat. No. 8,746,361, “Tillage Implement with Adjustable Gang Angle,” issued Jun. 10, 2014; and U.S. Pat. No. 9,688,399, “Dynamically Adaptive Soil Conditioning System,” issued Jun. 6, 2017.

The tillage implement 100 may be coupled to a control system 134 (typically located in the cab of a tractor pulling the tillage implement 100) configured to receive signals from the sensors 124 and the send signals to the adjustment mechanism 132. The control system 134 may also use other information in determining the appropriate settings for the gang assemblies 112, such as soil maps, weather history, etc.

Adjustments to gang assemblies of conventional tillage implements may be made based on information from soil maps programmed into a control system before tilling begins, or based on the operator's own experience and judgment before or during tilling. Producing soil maps can be expensive, particularly with fine resolution, because testing soil throughout an agricultural field typically requires passing sensors throughout the field. Furthermore, field conditions can change quickly, rendering old data relatively less useful. Basing operating parameters of tillage implements solely or primarily on operator experience and judgment introduces problems of tilling variations due to different operators and skill levels, as well as the physical and mental demand of making adjustments frequently enough and consistently enough during a tilling operation. Furthermore, reliance on operator skill limits the ability of a farmer to hire additional operators to complete tilling at the proper time in the season.

By adjusting the gang assemblies 112 of the tillage implement 100 based at least in part on information from the sensors 124 collected during a tilling operation, the operator can be freed from constant monitoring and adjustment of the gang angle and tillage depth. However, the control system 134 may still take an operator's preferences and judgment into account. For example, the operator may set preferences for aggressiveness of till, and the control system 134 may adjust operating parameters based on the operator's preferences. The operating parameters may be within the entire operating range of the gang assemblies 112 or within a subset of the operating range. For example, the operator may set the control system 134 to minimize gang angle whenever possible, and the control system 134 can then control the gang assemblies 112 to achieve that goal. The operator may set the control system 134 to base the operating parameters on one or more of the properties of the soil, which may be all or only a subset of the properties measured. For example, if the sensors 124 measure moisture and organic material content, but the agricultural field is in a wet region, the operator may choose to set the control system 134 to ignore the moisture measurements, and use only organic material content as a sensor input to calculate the operating parameter.

Another benefit of the sensors 124 is that actual data from the agricultural field can be collected in real time, and may be used to immediately make adjustments to the tillage implement 100 to improve tilling. The resolution of changes in operating parameters may be relatively finer than in conventional systems because the control system 134 can make a change as soon as a change in conditions is detected. In contrast, conventional systems may rely on relatively few data points collected days or weeks prior, or even a prior planting season.

The tillage implement 100 shown in FIG. 1 has two sensors 124—one for the left side and one for the right side gang assemblies 112. In other embodiments, the tillage implement 100 may include a single sensor 124, which may be carried by the hitch 104 near the lateral centerline of the tillage implement 100. Typically, if each of the wings (front right wing 116-rear right wing 120) are independently adjustable, having one sensor 124 for each side may enable different settings for each, corresponding to different conditions. If the tillage implement 100 does not have independent laterally adjacent gang assemblies 112, a single sensor 124 may provide sufficient data to help the control system 134 select appropriate operating parameters.

FIG. 3 is a simplified flow chart illustrating a method 300 in which the tillage implement 100 may be used for working an agricultural field. In block 302, a trench 202 is optionally formed in the agricultural field. The trench 202 may be formed with opening wheels 130 or another tool. In block 304, at least one sensor 124 passes within the trench 202. In block 306, a property of soil is detected using the sensors 124.

In block 308, an operating parameter of at least one gang assembly 112 of the tillage implement 100 is adjusted using the control system 134. For example, the gang assembly 112 may be moved relative to the frame 102 of the tillage implement 100. Typically, the gang angle or the depth of the disc blades 110 is adjusted based on or more settings or preferences, which may be preset by an operator. The operating parameter may also be based in part on a prescription map or other field data. In some embodiments, the operating parameter may be recorded as a function of location within the agricultural field so that the information may be used later (e.g., in nutrient application, analyzing yield, planning for subsequent seasons, etc.).

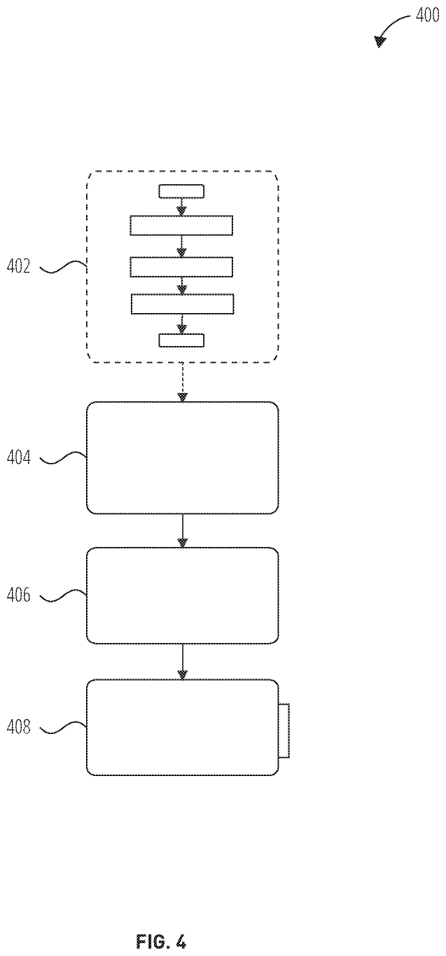

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 4, wherein an implementation 400 includes a computer-readable storage medium 402 (e.g., a flash drive, CD-R, DVD-R, application-specific integrated circuit (ASIC), field-programmable gate array (FPGA), a platter of a hard disk drive, etc.), on which is computer-readable data 404. This computer-readable data 404 in turn includes a set of processor-executable instructions 406 configured to operate according to one or more of the principles set forth herein. In some embodiments, the processor-executable instructions 406 may be configured to cause a computer associated with the tillage implement 100 (FIG. 1) to perform operations 408 when executed via a processing unit, such as at least some of the example method 300 depicted in FIG. 3. In other embodiments, the processor-executable instructions 406 may be configured to implement a system, such as at least some of the example tillage implement 100 depicted in FIG. 1. Many such computer-readable media may be devised by those of ordinary skill in the art that are configured to operate in accordance with one or more of the techniques presented herein.

Additional non-limiting example embodiments of the disclosure are described below.

Embodiment 1: A tillage implement comprising a frame, at least one sensor carried by the frame and configured to measure a property of soil, and at least one gang assembly carried by the frame and following the at least one sensor. Each gang assembly carries a plurality of disc blades. An adjustment mechanism is operable to change an operating parameter of the gang assembly responsive to the measured property of the soil.

Embodiment 2: The tillage implement of Embodiment 1, wherein the at least one sensor is configured to detect at least one property selected from the group consisting of moisture, amount of organic matter, soil density, and soil temperature.

Embodiment 3: The tillage implement of Embodiment 1 or Embodiment 2, wherein the at least one sensor comprises a sensor selected from the group consisting of a reflectivity sensor, an electrical conductivity sensor, and a temperature sensor.

Embodiment 4: The tillage implement of any of Embodiment 1 through Embodiment 3, further comprising at least one trench assembly carried by the frame, leading the at least one sensor, and configured to form a trench in which the at least one sensor travels when the tillage implement is drawn through an agricultural field.

Embodiment 5: The tillage implement of any of Embodiment 1 through Embodiment 4, wherein the at least one gang assembly comprises at least two gang assemblies.

Embodiment 6: The tillage implement of Embodiment 5, wherein the at least one sensor comprises a first sensor leading a first gang assembly and a second sensor leading a second gang assembly.

Embodiment 7: The tillage implement of any of Embodiment 1 through Embodiment 6, wherein the adjustment mechanism is operable to change a gang angle of the at least one gang assembly.

Embodiment 8: A method of working an agricultural field, the method comprising detecting a property of soil in the agricultural field using at least one sensor carried by a tillage implement; and adjusting an operating parameter of at least one gang assembly carried by the tillage implement and following the at least one sensor as the tillage implement traverses the field. The operating parameter is based at least in part on the property detected by the at least one sensor.

Embodiment 9: The method of Embodiment 8, wherein adjusting an operating parameter of the at least one gang assembly comprises adjusting a gang angle of the at least one gang assembly.

Embodiment 10: The method of Embodiment 8 or Embodiment 9, wherein adjusting an operating parameter of the at least one gang assembly comprises adjusting a depth of disc blades carried by the at least one gang assembly.

Embodiment 11: The method of any of Embodiment 8 through Embodiment 10, wherein adjusting an operating parameter of the at least one gang assembly comprises moving the at least one gang assembly relative to a frame of the tillage implement.

Embodiment 12: The method of any of Embodiment 8 through Embodiment 11, wherein adjusting an operating parameter of the at least one gang assembly comprises adjusting the operating parameter based at least in part on a setting preset by an operator.

Embodiment 13: The method of any of Embodiment 8 through Embodiment 12, wherein adjusting an operating parameter of the at least one gang assembly comprises adjusting the operating parameter based at least in part on a prescription map.

Embodiment 14: The method of any of Embodiment 8 through Embodiment 13, further comprising forming a trench leading the at least one sensor and passing the at least one sensor in the trench.

Embodiment 15: The method of any of Embodiment 8 through Embodiment 14, further comprising recording the operating parameter as a function of location in the agricultural field.

Embodiment 16: A non-transitory computer-readable storage medium, the computer-readable storage medium including instructions that when executed by a computer, cause the computer to perform the method of any one of Embodiment 8 through Embodiment 15.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A tillage implement, comprising: a frame; at least one sensor carried by the frame and configured to measure a property of soil; at least one gang assembly carried by the frame and following the at least one sensor,
each gang assembly carrying a plurality of disc blades; and an adjustment mechanism operable to change an operating parameter of the gang
assembly responsive to the measured property of the soil.

2. The tillage implement of claim 1, wherein the at least one sensor is configured to detect at least one property selected from the group consisting of moisture, amount of organic matter, soil density, and soil temperature.

3. The tillage implement of claim 1, wherein the at least one sensor comprises a sensor selected from the group consisting of a reflectivity sensor, an electrical conductivity sensor, and a temperature sensor.

4. The tillage implement of claim 1, further comprising at least one trench assembly carried by the frame, leading the at least one sensor, and configured to form a trench in which the at least one sensor travels when the tillage implement is drawn through an agricultural field.

5. The tillage implement of claim 1, wherein the at least one gang assembly comprises at least two gang assemblies.

6. The tillage implement of claim 5, wherein the at least one sensor comprises a first sensor leading a first gang assembly and a second sensor leading a second gang assembly.

7. The tillage implement of claim 1, wherein the adjustment mechanism is operable to change a gang angle of the at least one gang assembly.

8. A method of working an agricultural field, the method comprising: detecting a property of soil in the agricultural field using at least one sensor carried by a
tillage implement; and adjusting an operating parameter of at least one gang assembly carried by the tillage
implement and following the at least one sensor as the tillage implement
traverses the field, the operating parameter based at least in part on the property
detected by the at least one sensor.

9. The method of claim 8, wherein adjusting an operating parameter of the at least one gang assembly comprises adjusting a gang angle of the at least one gang assembly.

10. The method of claim 8, wherein adjusting an operating parameter of the at least one gang assembly comprises adjusting a depth of disc blades carried by the at least one gang assembly.

11. The method of claim 8, wherein adjusting an operating parameter of the at least one gang assembly comprises moving the at least one gang assembly relative to a frame of the tillage implement.

12. The method of claim 8, wherein adjusting an operating parameter of the at least one gang assembly comprises adjusting the operating parameter based at least in part on a setting preset by an operator.

13. The method of claim 8, wherein adjusting an operating parameter of the at least one gang assembly comprises adjusting the operating parameter based at least in part on a prescription map.

14. The method of claim 8, further comprising forming a trench leading the at least one sensor and passing the at least one sensor in the trench.

15. The method of claim 8, further comprising recording the operating parameter as a function of location in the agricultural field.

16. A non-transitory computer-readable storage medium, the computer-readable storage medium including instructions that when executed by a computer, cause the computer to: detect a property of soil in an agricultural field using at least one sensor carried by a
tillage implement; and adjust an operating parameter of at least one gang assembly carried by the tillage
implement and following the at least one sensor as the tillage implement
traverses the field, the operating parameter based at least in part on the property
detected by the at least one sensor.

17. The non-transitory computer-readable storage medium of claim 16, wherein the instructions cause the computer to record the operating parameter as a function of location in the agricultural field.

18. The non-transitory computer-readable storage medium of claim 16, wherein adjusting an operating parameter of the at least one gang assembly comprises adjusting the operating parameter based at least in part on a setting preset by an operator.

19. The non-transitory computer-readable storage medium of claim 16, wherein adjusting an operating parameter of the at least one gang assembly comprises adjusting the operating parameter based at least in part on a prescription map.
